(19) United States
(12) Patent Application Publication
(10) Pub. No.: US 2022/0368162 A1
(43) Pub. Date: Nov. 17, 2022

(54) POWER TRANSMISSION COIL, POWER TRANSMISSION DEVICE, AND UNDERWATER POWER SUPPLY SYSTEMS

(71) Applicant: PANASONIC CORPORATION, Osaka (JP)

(72) Inventors: Katsuya OKAMOTO, Tokyo (JP); Shuichiro YAMAGUCHI, Fukuoka (JP); Souichi KAWATA, Fukuoka (JP)

(73) Assignee: PANASONIC CORPORATION, Osaka (JP)

(21) Appl. No.: 17/763,464

(22) PCT Filed: Sep. 25, 2020
(86) PCT No.: PCT/JP2020/036429

§ 371 Date: Jun. 7, 2022

(30) Foreign Application Priority Data
Sep. 26, 2019 (JP) 2019-175943

(51) Int. Cl. H02J 50/12; H02J 50/00; H02J 50/40; H02J 50/80; B60L 53/12

(52) U.S. Cl. CPC H02J 50/12; H02J 50/005; H02J 50/402; H02J 50/80; B60L 53/12

(57) ABSTRACT

A power transmission coil includes a plurality of coil members each of which having a length capable of surrounding at least one power reception device located under water from all directions and that are configured to wirelessly transmit power to the power reception device. Each of the plurality of coil members includes a polygonal pipe having a polygonal shape in which a plurality of straight pipes are welded, and a conductive wire that is inserted into the polygonal pipe and is wound a plurality of times.

### TECHNICAL FIELD

The present disclosure relates to a power transmission coil, a power transmission device, and an underwater power supply system.

### BACKGROUND ART

An underwater base station is disclosed in the related art as a power transmission device that transmits power to an underwater vehicle serving as a power reception device in a non-contact manner by using a magnetic resonance method (see Patent Literature 1, for example). The power transmission device includes a power transmission resonance coil, a balloon, and a balloon control mechanism. The power transmission resonance coil transmits power to a power reception resonance coil of the power reception device in a non-contact manner by using a magnetic resonance method. The balloon includes the power transmission resonance coil therein. The balloon control mechanism removes water between the power transmission resonance coil and the power reception resonance coil by expanding the balloon during power transmission.

In addition, the related art discloses an antenna device that transmits power and data to an IC-integrated medium using an electromagnetic induction method in which a frequency of 13.56 MHz band is used (see Patent Literature 2, for example). This antenna device includes at least one power supply loop antenna to which a signal current is supplied and at least one parasitic loop antenna to which a signal current is not supplied, and also causes the parasitic loop antenna to generate a signal current using a magnetic field generated by the power supply loop antenna, thereby expanding a communication range of the power supply loop antenna.

### CITATION LIST

### Patent Literature

Patent Literature 1: JP-A-2015-015901

Patent Literature 2: JP-A-2005-102101

### SUMMARY OF INVENTION

### Technical Problem

Although Patent Literature 1 discloses that power is transmitted under water using a magnetic resonance method, a shape of the power transmission resonance coil is a helical coil wound in a spiral shape, and there is a problem that it is not actually easy to manufacture the power transmission resonance coil having such the spiral shape. In particular, in order to efficiently supply power wirelessly to an underwater moving body such as an autonomous underwater vehicle (AUV), for example, in a case where a coil has a large diameter such that power can be supplied in a state in which the autonomous underwater vehicle is surrounded from all directions, it is difficult to manufacture the coil having the shape described above. On the other hand, Patent Literature 2 discloses a use case in which a loop shape of the power supply loop antenna is circular, elliptical, substantially rectangular, or the like, but such power supply loop antenna is used for authentication in a wide communication range in an airport or a gate of a store, and it is assumed that power is not transmitted under water as in Patent Literature 1.

The present disclosure is made in view of the circumstances described above in the related art, and an object of the present disclosure is to provide a power transmission coil, a power transmission device, and an underwater power supply system that can contribute to simplification of manufacturing and can efficiently supply power to an underwater moving body by transmitting power under water.

### Solution to Problem

The present disclosure provides a power transmission coil. The power transmission coil includes a plurality of coil members each having a length capable of surrounding at least one power reception device located under water from all directions and that are configured to wirelessly transmit power to the power reception device. Each of the plurality of coil members includes a polygonal pipe having a polygonal shape in which a plurality of straight pipes are welded, and a conductive wire that is inserted into the polygonal pipe and is wound a plurality of times.

Further, the present disclosure provides a power transmission device that wirelessly transmits power to at least one power reception device located under water. The power transmission device includes a power transmission coil that includes a plurality of coil members each having a length capable of surrounding the power reception device from all directions, and a power transmission circuit configured to control power transmission from the power transmission coil to a power reception coil provided in the power reception device. Each of the plurality of coil members includes a polygonal pipe having a polygonal shape in which a plurality of straight pipes are welded, and a conductive wire that is inserted into the polygonal pipe and is wound a plurality of times.

Further, the present disclosure provides an underwater power supply system. The underwater power supply system includes a power transmission device located under water, and at least one power reception device. The underwater power supply system wirelessly transmits power from the power transmission device to the power reception device. The power reception device includes a power reception coil, the power transmission device includes a power transmission coil that transmits power to the power reception coil, and the power transmission coil includes a plurality of coil members each having a length capable of surrounding the power reception device from all directions. Each of the plurality of coil members includes a polygonal pipe having a polygonal shape in which a plurality of straight pipes are welded, and a conductive wire that is inserted into the polygonal pipe and is wound a plurality of times.

### Advantageous Effects of Invention

According to the present disclosure, it is possible to contribute to simplification of manufacturing and efficiently transmit power to an underwater moving body by transmitting power under water.

### BRIEF DESCRIPTION OF DRAWINGS

FIG. 1 is a diagram showing an example of an installation environment of an underwater power supply system according to a first embodiment.

FIG. 2 is a diagram showing a configuration example of the underwater power supply system.

FIG. 3 is a perspective view showing an example of an appearance of a power transmission coil.

FIG. 4 is a diagram showing an example of a shape of a hollow case having a regular octagonal shape.

FIG. 5 is a cross-sectional view showing an example of an inner side of the hollow case as viewed in a direction of arrows E-E in FIG. 3.

FIG. 6 is a diagram showing another example of a shape of a hollow case having a regular octagonal shape.

### DESCRIPTION OF EMBODIMENTS

Hereinafter, embodiments specifically disclosing a power transmission coil, a power transmission device, and an underwater power supply system according to the present disclosure will be described in detail with reference to the drawings as appropriate. Unnecessarily detailed description may be omitted. For example, detailed description of a well-known matter or repeated description of substantially the same configuration may be omitted. This is to avoid unnecessary redundancy in the following description and to facilitate understanding for those skilled in the art. The accompanying drawings and the following description are provided for a thorough understanding of the present disclosure for those skilled in the art, and are not intended to limit the subject matter in the claims.

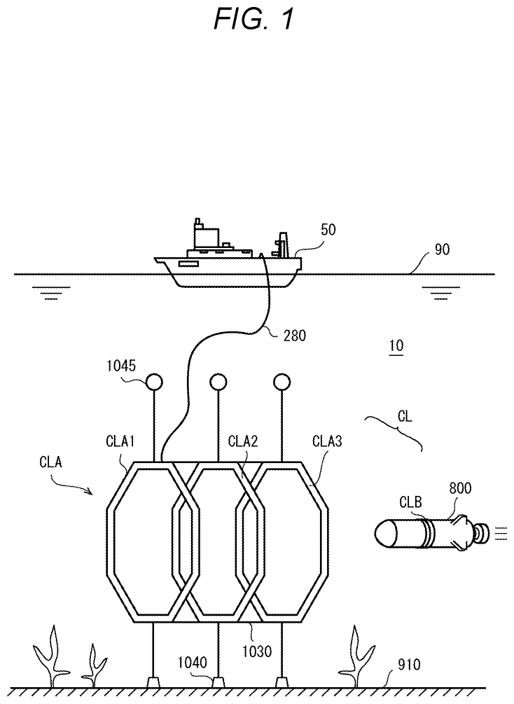

FIG. 1 is a diagram showing an example of an installation environment of an underwater power supply system 10 according to a first embodiment. For example, when an underwater vehicle explores underwater (for example, undersea) or the water bottom (for example, the seabed), the underwater power supply system 10 supplies power to the underwater vehicle so as to lengthen the operation of the underwater vehicle while the underwater vehicle is positioned under water or at the water bottom. The underwater vehicle can travel, for example, either in fresh water (for example, water of a dam lake) or in seawater. An example will be described in which an underwater vehicle travels in the sea as an underwater moving body to explore the sea or the seabed in the first embodiment. Similarly, the following description is applicable to a case where an underwater vehicle travels in water (fresh water) and explores under water or at the water bottom.

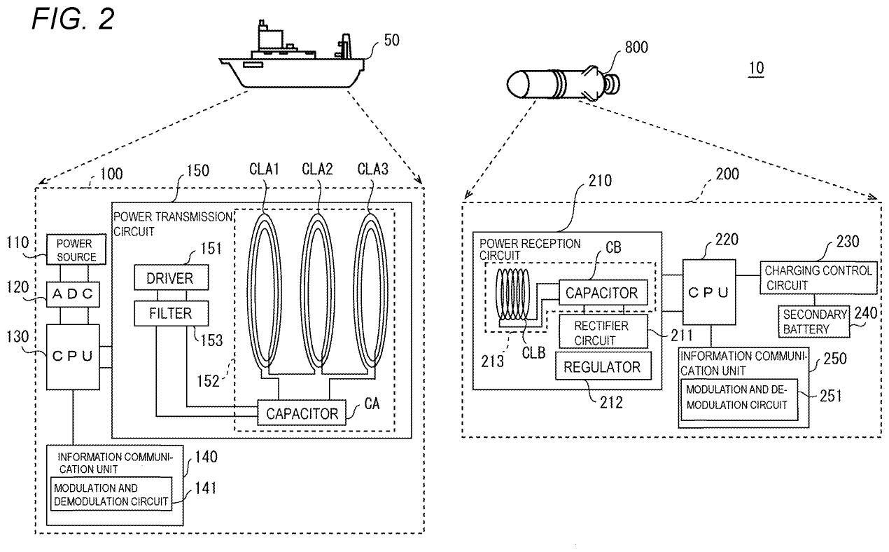

The underwater power supply system 10 includes a power transmission device 100 (see FIG. 2), a power reception device 200 (see FIG. 2), and a plurality of coils CL. Here, the coils CL are collectively referred to as three stages of coils CLA1, CLA2, and CLA3 at a power transmission side serving as an example of a plurality of coil members and a power reception coil CLB at a power reception side without being distinguished from one another. The power transmission device 100 transmits (supplies) power to the power reception device 200 via the plurality of coils CL (that is, from the coils CLA1, CLA2, and CLA3 at the power transmission side via the power reception coil CLB) in a wireless manner (that is, contactless) by using a magnetic resonance method. The number of coils CL described above is merely an example, and may be any number.

Each of the coils CL is formed into, for example, a substantially annular shape or an annular shape. The coil CL may be formed of, for example, a cabtyre cable. The coil CL may be formed of, for example, a helical coil or a spiral coil. The helical coil is a coil spirally wound (formed by helical winding) along a power transmission direction (also simply referred to as a “transmission direction”) rather than in the same plane. The spiral coil is a coil wound in the same plane (formed by spiral winding). A thickness of a coil CL can be reduced in the spiral coil. Therefore, even when it is difficult to secure the thickness of a coil CL, the coil CL can be molded. On the other hand, it is possible to secure a large space inside a wound coil CL in the helical coil. Here, a coil structure in which three spiral coils formed in three stages are connected in series is used as the power transmission coil CLA. A helical coil is used as the power reception coil CLB.

The power transmission coil CLA is a primary coil including three stages of coils CLA1, CLA2, and CLA3. On the other hand, the power reception coil CLB is a secondary coil.

The power transmission coil CLA is provided in the power transmission device 100. The power reception coil CLB is provided in the power reception device 200. A part of the power transmission device 100 may be installed in a ship 50, or may be disposed in another place (for example, a power supply facility (not shown) installed on land). The power reception device 200 is installed in a submarine that is a movable underwater vehicle. Examples of the submarine include a remotely operated vehicle (ROV), an unmanned underwater vehicle (UUV), and an autonomous underwater vehicle (AUV). Here, a case in which an AUV 800 is used as the submarine will be described.

The power reception device 200 may be installed on a seabed boring machine that is an underwater vehicle, a power reception device (for example, an seismometer, a monitoring camera, or a geothermal power generator) that is fixedly installed, or the like. In this manner, the plurality of coils CL are disposed under water (here, under sea).

An upper portion of the ship 50 is present above a sea surface 90 (that is, above the water), and a lower portion of the ship 50 is present under the sea. The ship 50 is movable on the sea, and for example, the ship 50 freely moves to a location on the sea where data related to a marine research or a marine exploration is acquired. The power transmission device 100 installed in the ship 50 and the power transmission coil CLA are connected to each other by a power cable 280. The power cable 280 is connected to, for example, a driver 151 (see FIG. 2) in the power transmission device 100 via a connector on the sea.

The AUV 800 travels under water. For example, according to an instruction from the ship 50 on the sea, the ship 50 can freely move to a location where data related to a marine research or a marine exploration is acquired. The instruction from the ship 50 may be transmitted by communication via each coil CL, or may be transmitted by another communication method.

The three stages of coils CLA1, CLA2, and CLA3 are arranged, for example, at equal intervals. A coil interval is, for example, about a half of a coil diameter. In consideration of attenuation of a magnetic field strength under water, a transmission frequency is, for example, 40 kilohertz (kHz) or less, and may be less than 10 kilohertz (kHz). In a case where power is transmitted at a transmission frequency of 10 kilohertz (kHz) or more, it is necessary to perform a predetermined simulation based on the regulation of Radio Act, and in a case where the transmission frequency is less than 10 kilohertz (kHz), this operation can be omitted. In the first embodiment, 30 kilohertz (kHz) is used as the transmission frequency. The lower the transmission frequency, the longer a wavelength, the longer a power transmission distance, the larger a diameter of the power transmission coil CLA, and the larger the coil interval. For example, when a communication signal is superimposed, the transmission frequency may be a frequency higher than 40 kilohertz (kHz).

The power transmission frequency is determined based on coil characteristics such as an inductance of the power transmission coil CLA, the diameter of the power transmission coil CLA, and the number of turns of the power transmission coil CLA. The diameter of the power transmission coil CLA is, for example, several meters (m) to several tens of meters (m). Here, a case of 2.4 meters (m) is used as an example. The power transmission coils CLA are arranged at equal intervals of, for example, a coil interval of 1 meter (m). As an electric wire of the power transmission coil CLA is thicker, that is, as the wire diameter of the power transmission coil CLA is larger, an electric resistance of the power transmission coil CLA is reduced and a power loss is smaller. The power transmitted via the power transmission coil CLA is, for example, 50 watts (W) or more, and may be on the order of kilowatt (kW).

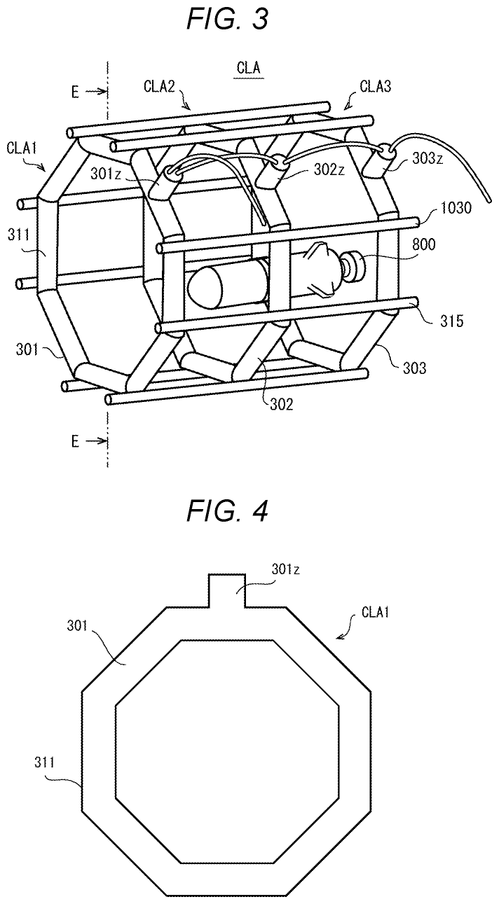

The three stages of coils CLA1, CLA2, and CLA3 included in the power transmission coil CLA construct a coil structure 1030 (see FIG. 3), and are installed on a seabed 910 as a power supply stand in a state in which the coil structure 1030 is disposed transversely. Here, although a case where the power transmission coil includes coils of three stages is described, the power transmission coil CLA is not limited to three stages, and may include coils of one stage, two stages, or four or more stages. It is preferable that the power transmission coil CLA includes coils of a plurality of stages in order to efficiently supply power to the AUV 800.

FIG. 1 shows an outline of the underwater power supply system, and members such as a hollow case for accommodating each coil of the power transmission coil CLA, a holding rod, and the like (see FIG. 3) are omitted. A weight 1040 is connected to a lower end side of the coil structure 1030. A buoy 1045 is connected to an upper end side of the coil structure 1030.

The weight 1040 restricts a movement of the coil structure 1030. Even when an ocean current, a tidal current, or the like occurs, a movement of each of the coils CLA1, CLA2, and CLA3 is restricted by the weight 1040, and thus a positional relationship between the power transmission coil CLA and the power reception coil CLB is relatively stable. Therefore, the efficiency of power transmission to the AUV 800 is prevented from being lowered.

The coil structure 1030 is maintained at a stable posture so as to be substantially horizontal to the sea surface between the weight 1040 placed on the seabed and the buoy 1045 that is operated by buoyancy under water. Inside the coil structure 1030, the power transmission coil CLA can transmit power in a horizontal direction.

The weight 1040 is removed from the coil structure 1030 when the coil structure 1030 is transported. In a case where the transportation of the coil structure 1030 is finished, the weight 1040 is attached to the coil structure 1030 when the coil structure 1030 is installed at a predetermined position. Therefore, it is easy to transport the coil structure 1030.

In this manner, when the coil structure 1030 is placed transversely on the seabed, the AUV 800 enters an inner side of the coil structure 1030, and power is easily supplied. The coil structure 1030 is lightweight and can be compactly accommodated.

The posture of the coil structure 1030 may be maintained in a state of floating in seawater, or may be maintained in a state of being fixed to a support column installed on the seabed. The coil structure 1030 may be placed longitudinally. In this case, the underwater power supply system 10 can transmit power in a water depth direction (that is, a direction substantially perpendicular to the sea surface).

FIG. 2 is a diagram showing a configuration example of the underwater power supply system 10. In the underwater power supply system 10, the power transmission device 100 includes a power source 110, an ADC 120, a CPU 130, an information communication unit 140, and a power transmission circuit 150.

The ADC 120 (AC/DC converter) converts AC power supplied from the power source 110 into DC power. The DC power after the conversion is transmitted to the power transmission circuit 150.

The central processing unit (CPU) 130 controls an operation of each unit (for example, the power source 110, the ADC 120, the information communication unit 140, and the power transmission circuit 150) of the power transmission device 100 in an integrated manner.

The information communication unit 140 includes a modulation and demodulation circuit 141 for modulating or demodulating communication data exchanged between the information communication unit 140 and the power reception device 200. For example, the information communication unit 140 transmits control information from the power transmission device 100 to the power reception device 200 via the plurality of coils CL. For example, the information communication unit 140 receives data transmitted from the power reception device 200 to the power transmission device 100 (for example, data that is related to a marine research or a marine exploration and is acquired by the power reception device 200) via the plurality of coils CL. The data includes, for example, data of an exploration result of a marine research or a marine exploration acquired by the power reception device 200. The information communication unit 140 quickly communicates data with the AUV 800 when the AUV 800 performs work such as data collection.

The power transmission circuit 150 includes the driver 151, a filter 153, and a resonance circuit 152. The driver 151 converts DC power from the ADC 120 into an AC voltage (a pulse waveform) of a predetermined frequency. The filter 153 shapes a waveform of the AC voltage having the pulse waveform from the driver 151, and generates an AC voltage having a sinusoidal waveform from the AC voltage having the pulse waveform. The resonance circuit 152 includes a capacitor CA and the power transmission coil CLA, and resonates at a predetermined resonance frequency in accordance with an AC voltage applied from the driver 151 via the filter 153. Since all of the three stages of coils CLA1, CLA2, and CLA3 connected in series in the power transmission coil CLA are supplied with power, power transmission efficiency is higher than power transmission efficiency in a case where a parasitic coil is interposed.

The power transmission coil CLA is impedance-matched to an output impedance of the power transmission device 100. A frequency of an AC voltage output from the driver 151 corresponds to a frequency of power transmission performed between the power transmission device 100 and the power reception device 200, that is, a resonance frequency when power is transmitted using a magnetic resonance method. The transmission frequency is set based on, for example, a Q value of each coil CL.

The power reception device 200 includes a power reception circuit 210, a CPU 220, a charging control circuit 230, a secondary battery 240, and an information communication unit 250. The power reception circuit 210 includes a rectifier circuit 211, a regulator 212, and a resonance circuit 213. The resonance circuit 213 includes a capacitor CB and the power reception coil CLB, and receives AC power transmitted from the power transmission coil CLA. The power reception coil CLB is impedance-matched to an input impedance of the power reception device 200. The rectifier circuit 211 converts AC power induced in the power reception coil CLB into DC power. The regulator 212 converts a DC voltage transmitted from the rectifier circuit 211 into a predetermined voltage suitable for charging the secondary battery 240.

The CPU 220 controls an operation of each unit (for example, the power reception circuit 210, the charging control circuit 230, the secondary battery 240, and the information communication unit 250) of the power reception device 200 in an integrated manner. The charging control circuit 230 controls charging of the secondary battery 240 according to a type of the secondary battery 240. For example, when the secondary battery 240 is a lithium ion battery, the charging control circuit 230 starts to charge the secondary battery 240 at a constant voltage using DC power from the regulator 212. The secondary battery 240 accumulates power transmitted from the power transmission device 100. The secondary battery 240 is, for example, a lithium ion battery.

The information communication unit 250 includes a modulation and demodulation circuit 251 for modulating or demodulating communication data exchanged between the information communication unit 250 and the power transmission device 100. For example, the information communication unit 250 receives control information transmitted from the power transmission device 100 to the power reception device 200 via the plurality of coils CL. For example, the information communication unit 250 transmits data from the power reception device 200 to the power transmission device 100 (for example, data that is related to a marine research or a marine exploration and is acquired by the power reception device 200) via the plurality of coils CL. The data includes, for example, data of an exploration result of a marine research or a marine exploration acquired by the power reception device 200. The information communication unit 250 quickly communicates data between the AUV 800 and the ship 50 when the AUV 800 performs work such as data collection.

Here, power transmission from the power transmission device 100 to the power reception device 200 using a magnetic resonance method will be described. In the resonance circuit 152, when an alternating current flows through the power transmission coil CLA of the power transmission device 100, a magnetic field is generated around the power transmission coil CLA. The vibration of the generated magnetic field is magnetically induced (that is, transmitted) to the resonance circuit 213 including the power reception coil CLB that resonates at the same frequency.

In the resonance circuit 213, an alternating current is induced in the power reception coil CLB by the vibration of the magnetic field of the power transmission coil CLA. The induced alternating current is rectified by the rectifier circuit 211 and converted into a predetermined voltage, thereby charging the secondary battery 240.

In this manner, since power is directly transmitted from the power transmission coil CLA to the power reception coil CLB without interposing a relay coil that is a parasitic coil between the power transmission coil CLA and the power reception coil CLB, power transmission efficiency is improved. A relay coil that is a parasitic coil may be interposed between the power transmission coil CLA and the power reception coil CLB, and power may be transmitted between the power transmission circuit and the power reception circuit via a resonance circuit including the relay coil. As a result, a distance between the power transmission coil and the power reception coil can be extended.

FIG. 3 is a perspective view showing an example of the appearance of the power transmission coil CLA. The power transmission coil CLA has a configuration in which the coils CLA1, CLA2, and CLA3 are arranged in three stages in the horizontal direction, and electric wires are connected in series.

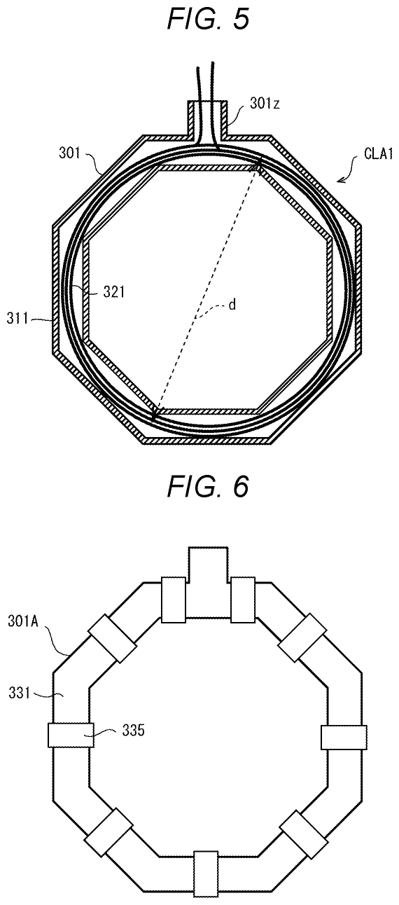

The coil CLA1 includes a hollow case 301 that accommodates an electric wire 321 (see FIG. 5) that is a coil conductor. Similarly, the coil CLA2 includes a hollow case 302 that accommodates an electric wire that is a coil conductor. The coil CLA3 includes a hollow case 303 that accommodates an electric wire that is a coil conductor.

Each of the hollow cases 301, 302, and 303 is formed into an octagonal pipe in which corner portions are positioned at apexes of a regular octagonal shape and eight straight pipes 311 are coupled to one another. A material of the hollow cases 301, 302, and 303 is a polyethylene pipe having sufficient strength and rigidity. In addition to the polyethylene pipe, a crosslinked polyethylene pipe or a resin pipe such as polypropylene, polyurethane, or fiber reinforced plastics (FRP) having excellent durability, processability, and the like may be used as a material of the hollow cases. A metal pipe is not used because the metal pipe shields electromagnetic waves. A shape of each of the hollow cases is not limited to an octagonal shape, and may be any polygonal shape such as a pentagonal shape or a dodecagon shape.

The hollow case 301, the hollow case 302, and the hollow case 303 are coupled at equal intervals by, for example, eight holding rods 315 to construct the coil structure 1030. A material of the holding rod may be resin having the same rigidity as the material of the hollow case, or may be a different material other than a material such as metal that shields electromagnetic waves. The coil structure 1030 is strengthened by the eight holding rods 315, and durability is improved. The coil structure 1030 is fixed in the sea or on the seabed, and serves as a power supply stand for supplying power to the AUV 800. The AUV 800 enters a space inside the coil structure 1030 from an opening at the hollow case 301 side or an opening at the hollow case 303 side, and stays in the coil structure 1030.

A pipe 301z protruding outward is coupled to an intermediate portion of the straight pipe 311 located obliquely above the hollow case 301, and the straight pipe 311 and the pipe 301z form a T-shaped pipe. An end portion of the pipe 301z serves as an outlet for two cables respectively connected to two ends of the electric wire of the coil CLA1. After the two cables are pulled out, the end portion of the pipe 301z is sealed. Similarly, a pipe 302z protruding outward is coupled to an intermediate portion of the straight pipe 311 located obliquely above the hollow case 302, and the straight pipe 311 and the pipe 302z form a T-shaped pipe. An end portion of the pipe 302z serves as an outlet for two cables respectively connected to two ends of the electric wire of the coil CLA2. After the two cables are pulled out, the end portion of the pipe 302z is sealed. Similarly, a pipe 303z protruding outward is coupled to an intermediate portion of the straight pipe 311 located obliquely above the hollow case 303, and the straight pipe 311 and the pipe 303z form a T-shaped pipe. An end portion of the pipe 303z serves as an outlet for two cables respectively connected to two ends of the electric wire of the coil CLA3. After the two cables are pulled out, the end portion of the pipe 303z is sealed.

One cable pulled out from the hollow case 301 is common to one cable pulled out from the hollow case 302. Similarly, the remaining one cable pulled out from the hollow case 302 is common to the one cable pulled out from the hollow case 303. The remaining one cable pulled out from the hollow case 301 and the remaining one cable pulled out from the hollow case 303 are respectively connected to two ends of the capacitor CA in the power transmission circuit 150. Accordingly, the coil CLA1, the coil CLA2, and the coil CLA3 form a series coil to which power is supplied from the power transmission circuit 150.

FIG. 4 is a diagram showing an example of a shape of a hollow case having a regular octagonal shape. Here, the shape of the hollow case 301 is shown, the same applies to the hollow cases 302 and 303, and thus the description of the hollow cases 302 and 303 will be omitted. The hollow case 301 accommodates the electric wire 321 of the coil CLA1. The hollow case 301 is formed into a regular octagonal pipe by welding and coupling end portions of eight straight pipes. In the welding, resin may be melted by irradiating joining surfaces of the straight pipes with ultrasonic waves and applying ultrasonic vibration energy to the joining surfaces. In addition, the welding may be performed by radiating electromagnetic waves having a high frequency of several tens of kilohertz (kHz) and causing the resin to generate heat by an electric field action of the electromagnetic waves to melt the resin. Pipe end portions may be joined to one another using an adhesive instead of welding.

FIG. 5 is a cross-sectional view showing an example of the inner side of the hollow case 301 as viewed in a direction of arrows E-E in FIG. 3. Here, the hollow case 301 will be described, the same applies to the hollow case 302 and the hollow case 303, and thus the description of the hollow cases 302 and 303 will be omitted.

The hollow case 301 has a structure in which the eight straight pipes 311 are coupled to one another and a ring-shaped space is formed inside the hollow case 301. Inside the hollow case 301, the electric wire 321 (a conductive wire) of the coil CLA1 is wound in ten turns. The number of turns of ten is merely an example, and the number of turns may be any number. Both end portions of the electric wire 321 of the coil CLA1 are connected to two cables leading to the outside through the pipe 301z. The electric wire 321 of the coil CLA1 is maintained in a circular shape while coming into contact with an inner side wall surface of the hollow case 301. That is, the electric wire 321 of the coil CLA1 comes into contact with a wall surface of an inner corner portion and an outer flat wall surface inside the hollow case 301, thereby the coil CLA1 is maintained in a circular shape without being positional deviated. Therefore, the inductance of the entire power transmission coil CLA is stabilized, and power transmission efficiency is improved.

(Method for Manufacturing Hollow Case Having Regular Octagonal Shape)

In a case where a diameter of the power transmission coil (a distance between centers of pipes) was 3.4 meters (m), the present inventors previously manufactured a circular hollow case having an inner diameter of a pipe in a range of 140 millimeters (mm) to 160 millimeters (mm) by rounding one polyethylene pipe into a circular shape and welding both end portions. In a case where a diameter d (see FIG. 5) of a power transmission coil is reduced to 2 meters (m), when one polyethylene pipe is rounded into a circular shape without changing an outer diameter of the pipe, a difference between an inner diameter and the outer diameter cannot be absorbed by the rigidity of the polyethylene pipe, and it is difficult to manufacture a circular hollow case.

Therefore, a regular octagonal hollow case is manufactured by joining a plurality of short and straight pipes by welding in the first embodiment. For example, a cable having a cross-sectional area of 100 square meters (mm²) and a diameter of 22.6 millimeters (mm) was used as a cable for the power transmission coil.

(Advantages of Regular Octagonal Hollow Case)

Here, a regular octagonal hollow case will be described. From the viewpoint of power transmission efficiency, the power transmission coil in the hollow case preferably has a circular shape. When the hollow case is formed of a material having low rigidity and is formed into an annular shape, deformation such as twisting or distortion is likely to occur in the hollow case. When the hollow case is deformed, the power transmission coil inside the hollow case is deformed, and an inductance of the power transmission coil changes. In a case where the inductance of the power transmission coil changes, a resonance frequency changes when power is transmitted using a magnetic resonance method. As a result, a difference in resonance frequency occurs between a power transmission circuit and a power reception circuit, and power transmission efficiency is lowered.

In the case of the first embodiment, since the hollow case is formed of a resin such as polyethylene having high rigidity and is formed into a regular octagonal outer shape, deformation such as twisting or distortion is less likely to occur as compared with the hollow case that is formed of a material having low rigidity and formed into an annular shape. Therefore, the electric wire of the power transmission coil disposed in the hollow case according to the first embodiment maintains a circular shape, a resonance frequency of the power transmission coil is stabilized, and power transmission efficiency is prevented from being lowered.

The electric wire of the power transmission coil is disposed in a circular shape in the hollow case in a manner in which the electric wire inscribes a corner portion of a regular octagonal shape formed by inner wall surfaces of the hollow case (a polygonal pipe) and circumscribes a straight portion of the regular octagonal shape formed by an outer wall surface of the hollow case. Here, an inner angle of the regular octagonal shape is 135°. That is, although the regular octagonal hollow case is a polygonal hollow case, the regular octagonal hollow case is a hollow case extremely close to an annular shape. Therefore, the electric wire that passes through an inner side of the regular octagonal hollow case can be maintained in a circular shape without being deformed while the electric wire comes into contact with a wall surface of an inner corner portion and comes into contact with an outer flat wall surface of the hollow case. Since the electric wire comes into contact with the wall surfaces, a positional deviation is less likely to occur. As a result, the electric wire of the power transmission coil is fixed in the hollow case, and a change in the shape of the electric wire is prevented, so that the power transmission coil can maintain a stable inductance and can transmit power at a stable resonance frequency. In addition, since the electric wire of the power transmission coil has a circular shape in a similar manner to the case where the electric wire passes through an annular hollow case, high power transmission efficiency is expected.

For example, when the hollow case is formed into a regular pentagonal shape, an inner angle is 108°. When the electric wire of the power transmission coil having the same circular shape and the same diameter as the electric wire of the power transmission coil having the regular octagonal shape is used in the regular pentagonal hollow case, the inner angle (108°) is close to a right angle in the regular pentagonal hollow case. When the electric wire passes through the hollow case, the electric wire is likely to be caught at a corner portion and cannot easily pass through the hollow case. An opening of the hollow case, that is, an inlet and outlet of an AUV is narrow. Therefore, for example, the number of AUVs to be supplied with power is limited to one, and it is difficult to supply power to two AUVs at the same time.

On the other hand, when the hollow case is formed into a regular dodecagon shape, an inner angle is 150°. In each of hollow cases 301 to 303, the electric wire is less likely to be caught by a corner portion, and the electric wire can pass through the hollow cases 301 to 303 more easily than the regular octagonal hollow case. When a regular polygonal hollow case is manufactured, the hollow case preferably have a shape from a regular octagonal shape to a regular dodecagon shape in which the electric wire that passes through the hollow case has a circular shape and an increase in manufacturing cost is prevented.

As described above, since each of the hollow cases 301 to 303 is formed into a regular octagonal shape in the power transmission coil CLA according to the first embodiment, a hollow case can be easily manufactured by coupling eight straight pipes by welding. When a size of the power transmission coil is relatively small, for example, when a diameter of the power transmission coil is 2 meters (m) and a diameter of a pipe is 160 millimeters (mm) to 200 millimeters (mm), it is difficult to bend the pipe having high rigidity into an annular shape, and the pipe is likely to be damaged. On the other hand, in the case of a regular octagonal hollow case, it is only necessary to couple eight straight pipes by welding, and processing is easy. Therefore, in the underwater power supply system 10 that requires a large number of power transmission coils, the yield is increased and the manufacturing cost is reduced. In view of the fact that each of the hollow cases 301 to 303 serving as an example of a polygonal pipe is entirely sunk under water, each of the hollow cases 301 to 303 may be sealed by being filled with a waterproof resin material or the like. As a result, it is possible to prevent seawater or fresh water from entering the inner side of each of the hollow cases 301 to 303.

(Other Regular Octagonal Hollow Case)

FIG. 6 is a diagram showing another example of a shape of a regular octagonal hollow case 301A. Similarly to the hollow case 301, the hollow case 301A has a shape in which straight pipes are coupled to form a regular octagonal shape. A material of the hollow case 301A is a polyethylene pipe in a similar manner to the hollow case 301, and the material of the hollow case 301A may be a crosslinked polyethylene pipe, a resin pipe such as polypropylene, polyurethane, and FRP.

When the regular octagonal hollow case 301A is manufactured, first, two straight pipes are welded such that an inner angle of a corner portion is 135°, and eight L-shaped pipes, that is, eight bent pipes 331 having an inner angle of 135° are manufactured. Of the eight L-shaped pipes, two L-shaped pipes are coupled at one side end portion to form a T-shaped pipe, so that a pipe length from the corner portion to the end portion is short. The T-shaped pipe is a pipe for taking out a cable, and is a single pipe. The L-shaped pipes are coupled to each other by a joint 335.

The joint 335 has an outer diameter slightly larger than an outer diameter of the straight pipe, and is formed of a resin material having high rigidity. The resin material of the joint may be the same as or different from the resin material of the hollow case as long as the resin material does not shield electromagnetic waves. In the joint, the pipes are coupled to each other only by inserting the pipes into holes on both sides of the joint without welding the pipes to each other. Once the pipes are inserted into the holes of the joint, the pipes are prevented from coming off. The joint may have screw holes around which waterproof tapes are wound at both ends, and the pipes may be coupled to each other by screwing the pipes into the screw holes.

It is easy to manufacture a hollow case using the joint as compared with a case where the hollow case is integrally formed by welding. Since the bent pipes are coupled using the joint, for example, when one of the eight bent pipes is damaged, the damaged portion is removed and the bent pipes are partially replaced with a new pipe, so that the regular octagonal hollow case can be easily repaired. Therefore, maintainability of the hollow case is improved.

As described above, the coil structure 1030 in which the hollow cases 301, 302, and 303 are coupled to one another by the eight holding rods 315 is constructed in the underwater power supply system 10 according to the first embodiment. The coil structure 1030 serves as a power supply stand installed transversely. In the transversely installed power supply stand, the AUV 800 can easily enter a space inside the power supply stand from an opening at the hollow case 301 side or an opening at the hollow case 303 side, as compared with a power supply stand in which the coil structure is longitudinally installed. Normally, the AUV 800 often moves under water in the horizontal direction, and an inlet and an outlet of the power supply stand are disposed transversely, so that the AUV 800 easily enters the power supply stand and easily leaves the power supply stand. In addition, since an ocean current or a tidal current also flows in a substantially horizontal direction, the AUV can easily find the inlet and the outlet of the power supply stand even when an ocean current or a tidal current occurs.

As described above, the power transmission coil CLA has a length capable of surrounding at least one power reception device 200 (for example, the AUV 800) located under water from all directions, and includes the three stages of coils CLA1, CLA2, and CLA3 serving as a plurality of coil members that wirelessly transmit power to the power reception device in the first embodiment. Each of the three stages of coils CLA1, CLA2, and CLA3 includes the regular octagonal (that is, a polygonal pipe having a polygonal shape) hollow case 301 in which eight straight pipes 311 serving as a plurality of straight pipes are welded and the electric wire 321 serving as a conductive wire that is inserted into the regular octagonal hollow case 301 and is wound in, for example, ten turns (a plurality of times).

As a result, the power transmission coil CLA can contribute to simplification of manufacturing, and can transmit power in a state in which the AUV 800 which is an underwater vehicle (an example of an underwater moving body) can be surrounded from all directions, and thus the power transmission coil CLA can efficiently supply power to the AUV 800.

The three stages of coils CLA1, CLA2, and CLA3 are connected in series. As a result, since all of the coils CLA1, CLA2, and CLA3 are used for power supply in a state in which the coils CLA1, CLA2, and CLA3 are connected in series, the efficiency of power transmission to the AUV 800 is higher than the efficiency of power transmission in a case where a parasitic coil is interposed.

The three stages of coils CLA1, CLA2, and CLA3 are fixed by at least one holding rod 315 that has rigidity and is formed of a material other than metal. As a result, the coil structure is strong, and durability and positional stability are improved under water in which a tidal flow exists.

A shape of the hollow case 301 is, for example, a regular octagonal shape serving as a polygonal shape having five or more sides. Accordingly, it is only necessary to weld and couple eight straight pipes, and processing of the regular octagonal hollow case is easy. In the underwater power supply system 10 that requires a large number of power transmission coils, a yield is increased and the manufacturing cost is reduced.

The electric wire 321 is disposed in a circular shape in the hollow case 301. As a result, the electric wire 321 of the power transmission coil has a circular shape as in the case where the electric wire 321 is disposed in a manner of passing through the inner side of the annular hollow case, and thus high power transmission efficiency is expected.

In the hollow case 301A, the bent pipe 331 bent at an obtuse angle is formed by welding two straight pipes 311, and eight bent pipes 331 are coupled by a plurality of joints 335. Accordingly, it is easy to manufacture a hollow case using the joints as compared with a case where the hollow case is integrally formed by welding. Since the pipes are coupled using the joints, for example, when one of the eight bent pipes is damaged, the damaged portion is removed and the bent pipes are partially replaced with a new pipe, so that the regular octagonal hollow case can be easily repaired. Therefore, maintainability of the hollow case is improved.

The coil structure 1030 constituted by the three stages of coils CLA1, CLA2, and CLA3 that are fixed by the holding rods 315 is installed in a substantially horizontal direction under water. Accordingly, the AUV 800 is moved and is supplied with power. It is easy to enter and leave the inner side of the coil structure which is a power stand.

The electric wire 321 is disposed in a circular shape in the regular octagonal hollow case in a manner in which the electric wire 321 inscribes a corner portion of the regular octagonal shape (an example of a polygonal shape) formed by inner wall surfaces of the regular octagonal hollow case and circumscribes a straight portion of the regular octagonal shape formed by an outer wall surface of the regular octagonal hollow case. As a result, the electric wire of the power transmission coil is fixed in the hollow case without positional deviation, and a change in the shape of the electric wire is prevented, so that the power transmission coil can maintain a stable inductance. Therefore, the power transmission coil CLA can transmit power at a stable resonance frequency.

Each of the hollow cases 301 to 303 serving as an example of a polygonal pipe is sealed (enclosed), and has a structure capable of preventing seawater or fresh water from entering the inner side of each of the hollow cases 301 to 303. When the hollow cases 301 to 303 are filled with a liquid (for example, oil) instead of a gas such as air, pressure resistance against water pressure under water can be improved.

The power transmission device 100 wirelessly transmits power to at least one power reception device 200 located under water in the first embodiment. The power transmission device 100 includes the power transmission coil CLA including a plurality of coil members each having a length capable of surrounding the power reception device 200 from all directions, and the power transmission circuit 150 configured to control power transmission from the power transmission coil CLA to the power reception coil CLB provided in the power reception device 200. Each of the plurality of coils CLA1, CLA2, and CLA3 includes a polygonal pipe having a polygonal shape in which a plurality of straight pipes are welded, and a conductive wire that is inserted into the polygonal pipe and is wound a plurality of times.

As a result, the power transmission device 100 can contribute to simplification of the manufacture of the power transmission coil CLA, and can transmit power in a state in which the AUV 800 which is an underwater vehicle (an example of an underwater moving body) can be surrounded from all directions, and thus the power transmission device 100 can efficiently supply power to the AUV 800.

In the first embodiment, the underwater power supply system 10 includes the power transmission device 100 located under water and at least one power reception device 200, and wirelessly transmits power from the power transmission device 100 to the power reception device 200. The power reception device 200 includes the power reception coil CLB, and the power transmission device 100 includes the power transmission coil CLA that transmits power to the power reception coil CLB. The power transmission coil CLA includes a plurality of coil members (for example, the coils CLA1, CLA2, and CLA3) having a length capable of surrounding the power reception device 200 from all directions. Each of the plurality of coil members includes a polygonal pipe having a polygonal shape in which a plurality of straight pipes are welded, and a conductive wire that is inserted into the polygonal pipe and is wound a plurality of times.

As a result, the underwater power supply system 10 can contribute to simplification of the manufacture of the power transmission coil CLA of the power transmission device 100, and can transmit power in a state in which the AUV 800 which is an underwater vehicle (an example of an underwater moving body) can be surrounded from all directions, and thus the underwater power supply system 10 can efficiently supply power to the AUV 800.

Although various embodiments are described above with reference to the drawings, it is needless to say that the present disclosure is not limited to such examples. It will be apparent to those skilled in the art that various alterations, modifications, substitutions, additions, deletions, and equivalents can be conceived within the scope of the claims, and it should be understood that such changes also belong to the technical scope of the present disclosure. Further, components in various embodiments described above may be combined freely in a range without deviating from the spirit of the invention.

For example, since the hollow case is formed by coupling the straight pipes having a circular cross section in the first embodiment described above, the pipe cross section is circular. In a case where the straight pipes having a polygonal cross section are coupled, the pipe cross section may be a polygonal shape including a rectangle.

Although a case where the underwater power supply system 10 wirelessly supplies power to the AUV 800 that explores the sea (for example, in the sea or at the seabed) has been described, power may be supplied to an industrial machine, a work robot, or the like that operates in the sea (see the above description).

Although a case where the underwater power supply system 10 supplies power in the sea has been described in the first embodiment described above, the present invention is not limited to the sea, and power may be supplied to an underwater moving body such as the AUV 800 in fresh water such as a lake including a dam lake, a river, and a water reservoir.

The present application is based on Japanese Patent Application NO. 2019-175943 filed on Sep. 26, 2019, and the contents of which are incorporated by reference in the present application.

### INDUSTRIAL APPLICABILITY

The present disclosure is useful as a power transmission coil, a power transmission device, and an underwater power supply system that can contribute to simplification of manufacturing, and can efficiently supply power to an underwater moving body by power transmission under water.

### REFERENCE SIGNS LIST

10 underwater power supply system
110 power source
100 power transmission device
120 ADC
130, 220 CPU
140, 250 information communication unit
141, 251 modulation and demodulation circuit
200 power reception device
211 rectifier circuit
212 regulator
230 charging control circuit
240 secondary battery
301, 302, 303 hollow case
321 electric wire
800 AUV
CLA power transmission coil
CLB power reception coil

1. A power transmission coil comprising:
a plurality of coil members, each of which having a length capable of surrounding at least one power reception device located under water from all directions, and that are configured to wirelessly transmit power to the power reception device,
wherein each of the plurality of coil members comprises:
a polygonal pipe having a polygonal shape in which a plurality of straight pipes are welded to one another; and
a conductive wire that is inserted into the polygonal pipe and is wound a plurality of times.

2. The power transmission coil according to claim 1, wherein the plurality of coil members are connected in series.

3. The power transmission coil according to claim 1, wherein the plurality of coil members are fixed by at least one holding rod having rigidity and being formed of a material other than metal.

4. The power transmission coil according to claim 1, wherein the polygonal shape is a polygonal shape having five or more sides.

5. The power transmission coil according to claim 1, wherein the conductive wire is disposed in a circular shape in the polygonal pipe.

6. The power transmission coil according to claim 1, wherein a bent pipe bent at an obtuse angle is formed by welding two straight pipes and the polygonal pipe is formed by coupling eight bent pipes by a plurality of joints.

7. The power transmission coil according to claim 3, wherein the plurality of coil members fixed by the holding rod are installed in a substantially horizontal direction under water.

8. The power transmission coil according to claim 5, wherein the conductive wire is disposed in the circular shape in the polygonal pipe in a manner in which the conductive wire inscribes a corner portion of a polygonal shape formed by inner side wall surfaces of the polygonal pipe and substantially circumscribes a straight portion of a polygonal shape formed by an outer side wall surfaces of the polygonal pipe.

9. The power transmission coil according to claim 1, wherein the polygonal pipe is sealed.

10. A power transmission device for wirelessly transmitting power to at least one power reception device located under water, the power transmission device comprising:
a power transmission coil that comprises a plurality of coil members each having a length capable of surrounding the power reception device from all directions; and
a power transmission circuit configured to control power transmission from the power transmission coil to a power reception coil provided in the power reception device,
wherein each of the plurality of coil members comprises:
a polygonal pipe having a polygonal shape in which a plurality of straight pipes are welded to one another; and
a conductive wire that is inserted into the polygonal pipe and is wound a plurality of times.

11. An underwater power supply system comprising:
a power transmission device located under water; and
at least one power reception device,
wherein the underwater power supply system wirelessly transmits power from the power transmission device to the power reception device;
wherein the power reception device comprises a power reception coil;
wherein the power transmission device comprises a power transmission coil configured to transmit power to the power reception coil;
wherein the power transmission coil comprises a plurality of coil members each having a length capable of surrounding the power reception device from all directions; and
wherein each of the plurality of coil members comprises:
a polygonal pipe having a polygonal shape in which a plurality of straight pipes are welded to one another; and
a conductive wire that is inserted into the polygonal pipe and is wound a plurality of times.
